(19) United States
(12) Patent Application Publication
(10) Pub. No.: US 2006/0222348 A1
(43) Pub. Date: Oct. 5, 2006

(54) Temperature sensing in a steam boiler

(75) Inventors: Max Rosenzweig, Montreal (CA); Terry Robertson, Auburn, AL (US); Mark Montgomery, West Newton, MA (US); Ogi Vrdoljak, Montreal (CA)

Correspondence Address: VENABLE LLP, P.O. BOX 34385, WASHINGTON, DC, 20045-9998, US

(73) Assignee: Euro-Pro Operating, LLC, West Newton, MA (US)

(21) Appl. No.: 11/083,085

(22) Filed: Mar. 18, 2005

(51) Int. Cl. F24H 1/18; A47J 27/00; A47J 31/54

(52) U.S. Cl. 392/441

(57) ABSTRACT

A steam generation apparatus is set forth including a boiler adapted to generate steam from water; a thermostat; a sensing element having a portion protruding inside said boiler adapted to make contact with the water, the sensing element coupled to a wall of said boiler, and coupled to said thermostat for providing temperature of the water to said thermostat. The sensing element may be screw shaped, and may be threaded. The sensing element may pass through the wall of the boiler. The sensing element may include a portion inside the boiler and a portion outside the boiler coupled to the thermostat.

### BACKGROUND OF THE INVENTION

1. Field of the Invention

This invention pertains generally to boilers, and more particularly to steam boilers and temperature sensing devices for consumer steam boilers.

2. Related Art

Portable steamers which may be used for cleaning have become increasingly popular in recent years. Steaming devices used to apply steam to household objects are well known. The uses of the devices vary widely, and may include application of steam to drapes or other fabrics to ease wrinkles, and application of steam to objects to assist in cleaning the objects.

Conventionally, portable steamers can be battery-powered or can be electrically powered by a power cord which may be plugged in a conventional electric outlet. Typical steam devices may use the electrical power to power a heating element to heat water in a steam generation unit, or boiler. The heated water generates steam, which may be directed towards its intended destination through a nozzle which controls application of the steam. Nozzles may typically be disconnectable from the steam generation unit to allow different nozzles to be used, based on the object to be steamed. The nozzle may be closely coupled to the steam generation unit, or may be located at a distance from the steam generator and may be coupled by tubing or other steam transfer structures interconnecting the steam generator and discharge nozzles. Most steamers have a hose which may be used to transport the steam from the steam generation unit, or boiler, to the point of use of the steam.

The heating element used to heat water in a steam generation unit, or boiler is conventionally electronically coupled to a thermostat which may be used to sense temperature. Conventionally, the thermostat is placed at the bottom of the boiler on the outside of the boiler. Conventionally, the thermostat may be near the heating element.

What is needed is an invention that will improve performance of steam generation units having a heating element placed outside of the boiler with use of surface mount thermostat. Conventionally, a steam cleaner may have a low discharge pressure when continuously used. This low pressure may be caused by cycling on and off of the thermostat. Conventionally, the thermostat may be influenced by the heating element. Conventionally, the thermostat may be located in the center of the heating element. Unfortunately, a thermostat may become heated by the heating element causing a false reading since the conventional thermostat may be hotter than the surface that the thermostat may be reading or sensing.

### SUMMARY OF THE INVENTION

In accordance with an exemplary embodiment of the present invention, an improved boiler for use in a steam generating device is set forth. A steam generation apparatus and boiler are set forth including a boiler adapted to generate steam from water; a thermostat; a sensing element having a portion protruding inside the boiler adapted to make contact with the water, the sensing element coupled to a wall of the boiler, and the sensing element coupled to the thermostat for providing temperature of the water to the thermostat. The sensing element may be screw shaped, nail shaped, T-shaped, I-shaped, L-shaped or otherwise. The sensing element may pass through the wall of the boiler. The sensing element may be threaded and may be adapted to be threaded through a threaded opening in the wall of the boiler. The sensing element may include a portion inside the boiler and a portion outside the boiler coupled to the thermostat. The sensing element may include a flange to serve as a heat transfer fin.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 depicts an exemplary cutaway isometric view of a boiler including a sensing element protruding into the boiler, in accordance with an exemplary embodiment of the present invention;

FIG. 2 depicts a side cross-sectional view of an exemplary sensing element in accordance with an exemplary embodiment of the present invention;

FIG. 3A depicts an exemplary boiler and a housing of an exemplary steam generation device that may include a sensing element in accordance with an exemplary embodiment of the present invention;

FIG. 3B depicts an exemplary hose group and handle having a trigger of a steam generation device in accordance with an exemplary embodiment of the present invention;

FIG. 3C depicts exemplary accessories including pipes, steam pocket floor brush, a squeegee, a shoulder strap, a funnel, and packing materials in accordance with an exemplary embodiment of the present invention; and

FIG. 4 depicts a parts list table providing an exemplary list of components of the steam generation device of FIGS. 3A-C according to an exemplary embodiment of the present invention.

### DETAILED DESCRIPTION OF EXEMPLARY EMBODIMENTS OF THE PRESENT INVENTION

According to an exemplary embodiment of the present invention, a steam generation device, or boiler may be modified to provide for better temperature sensing.

In an exemplary embodiment of the present invention, an improvement may provide an increase in sensitivity of a thermostat in connection with a steam boiler.

Conventional steam generation devices may include any of various devices for sensing pressure and temperature in a steam boiler. In order to control the pressure in a steam boiler, one of two different devices may be used, a pressostat, or a thermostat.

A pressostat is a pressure sensing device which may be connected to a micro-switch. When the pressure reaches a predetermined level, the micro-switch may open and may disconnect the power circuit from the heating element. Although a pressostat may be a good solution for sensing pressure in a boiler, conventionally the cost may be too high.

A thermostat may be used to sense temperature in a boiler. Since temperature is directly proportional to pressure (per Bernoulli's Law), by sensing changes in temperature inside the boiler, changes in pressure may be identified indirectly as well. A thermostat may be used to measure the temperature of water inside the boiler. This is generally done by attaching a thermostat to the bottom of the boiler.

Conventionally, the thermostat is attached to the bottom (outer surface) of the boiler to measure the temperature of the bottom of the boiler as an approximation of the temperature of the water at the bottom of the boiler. This is done since the temperature of the bottom of the boiler is generally about the same as the temperature inside the boiler. However, generally the outer surface of the boiler is not necessarily the same temperature as the water temperature inside the boiler. It is desirable that a thermostat used in a steam generation device be provided increased sensitivity.

Increased sensitivity of the themostat according to the exemplary embodiment of the present invention may increase the average level of steam pressure, and may improve the cleaning ability of the steam cleaner.

An exemplary embodiment of the present invention may include a hole which may be formed in the bottom of the boiler. In an exemplary embodiment of the present invention, the boiler may further include a screw or nail-shaped sensing element. In an exemplary embodiment, one portion of the sensing element may be inserted into the hole in the boiler, and the base (or head) of the screw shaped may be coupled to the bottom of the boiler. In one exemplary embodiment, the base of the screw may, e.g., but not limited to, be welded or soldered to the bottom of the boiler. Although referred to as a screw-shaped part, the sensing element, in an exemplary embodiment may be any of a number of other shapes such as, e.g., but not limited to, a nail, a L-shaped, I-shaped, T-shaped member, or any other shaped member including a first portion inserted within the boiler and a second portion which may be coupled to the thermostat. In an exemplary embodiment of the present invention, the sensing element may include, e.g., but not limited to, a protrusion which may extend into the inside of the boiler, so as to allow the sensing element to measure water temperature within the boiler. In an exemplary embodiment, the thermostat may be coupled to the base of the sensing element. In one exemplary embodiment, the base, or head of the screw-shaped sensing element may be coupled to the thermostat. In an exemplary embodiment, the base of the sensing element may protrude out of the bottom of the boiler.

According to an exemplary embodiment of the present invention, a long portion of the screw-shaped sensing element may be immersed in the water inside the boiler, to allow sensing of the temperature of the water inside the boiler. In one exemplary embodiment, the long portion may sense a change of the water temperature at an earlier time than was conventionally sensed using a thermostat coupled to the bottom of the boiler. In an exemplary embodiment, the thermostat, which may be attached to the head of the screw-shaped portion of the sensing element, may now detect more quickly any temperature changes in the water. Thus, the present invention may provide increased temperature sensitivity than conventional solutions. In an exemplary embodiment, the extra sensitivity in measuring water temperature inside the boiler may increase an average level of the steam pressure, and may further improve the cleaning ability of the steam cleaner.

According to an exemplary embodiment of the present invention, a sensing element may transmit the boiler water temperature to the thermostat. Various methods and apparatuses are described to provide this feature, however these should be taken as exemplary, and non limiting. In one exemplary embodiment, the water temperature may be transmitted directly to the thermostat. Advantageously, using some exemplary embodiments of the present invention, regardless of the orientation of the steam generation device, the thermostat can detect the boiler water temperature.

It may be helpful to note that a difference between saturation temperature at 2.3 bars and 2.0 bars is 5.9° C., in an exemplary embodiment of the present invention.

In an exemplary embodiment, the sensing element may be stainless steel when used within a stainless steel boiler. In one embodiment, three features may be maintained for the material used in the sensing element in various exemplary embodiments of the present invention: 1) a good heat transfer capability, 2) material compatibility, and 3) material that may not corrode or foul easily. Like materials may also have similar coefficients of expansion—if the coefficients of expansion of the material vary too much, this might cause a weld to fail due to cycling.

One exemplary embodiment may include creating a hole in the wall of the boiler, inserting the sensing element through the wall and welding/soldering the sensing element in place. In another exemplary embodiment, an alternative method may be used, such as, e.g., but not limited to, welding a threaded coupling (or threaded molding) in a boss, and threading the sensing element into the wall of the boiler.

In another exemplary embodiment, the sensing element may not pass through the wall. Instead, in another exemplary embodiment, a first mass may be placed on the inside of the boiler, and a second mass may be placed on the outside of the boiler (which may be adjacent, and may be directly in line with the first mass, on the opposite side of the boiler wall). This alternative exemplary embodiment, may achieve a similar affect to other exemplary embodiments, however there may be two additional contact resistances and a need to mount the masses on the boiler wall.

In an exemplary embodiment, the sensing element may have more than a minimal mass associated with it. In one exemplary embodiment, an optimum design may place the sensing element at the bottom of the pressure vessel. In another exemplary embodiment, the sensing element may be placed such that more of the water may be put in contact with the sensing element. Placing the sensing element in contact with water (i.e., generally near the bottom of the vessel) rather than in contact with steam, may likely provide a quicker response to changes in temperature of water in the boiler, due to a higher coefficient of conductive heat transfer of water than steam.

However, in another exemplary embodiment, if the mass of the sensing element is very small, so that the sensing element's temperature can change quickly, then mounting the sensing element in the steam space may result in a faster response. This alternative embodiment may achieve the faster response based upon a sequence of pressure/temperature adjustment in the boiler. The sequence of pressure/temperature adjustment may include, first the steam leaving, the pressure dropping, then the water, having more energy than it can hold at the lower pressure, may give up energy by flashing some of water to steam. The change of the water temperature may be last in sequence.

The thermal mass of the sensing element may be large enough to overcome (or outweigh) affects of heat coming through the boiler wall from the adjacent heating element, but not so large that changes in water temperature take a long time to work their way through the sensing element to the interface with the thermostat. An exemplary optimal sensing element may have some sort of extended surface on the inside of the boiler. In one exemplary embodiment, the sensing element may be inserted from the outside, or the inside of the boiler vessel, before welding the two boiler halves together.

In one exemplary embodiment, a rod of stainless steel may be used as a sensing element, with a diameter approximately the same as, or perhaps slightly larger than what is needed to mount the thermostat. In one exemplary embodiment, a common stock size screw may be used. For example, in one exemplary embodiment, a screw size #12, ¾, may be used. Alternatively, another size screw may be used. Alternatively, a sensing element could be so-called “turned down” if needed. In another exemplary embodiment, channels or slots may be cut or ground (such as, e.g., but not limited to, cutting in cross hairs) that may allow more of the metal of the sensing element to be in direct contact with the water. The sensing element may be relatively short in height, or squat in shape, to increase the likelihood that the sensing element might remain immersed in the water. The slots or channels should not be too deep to allow for a good weld.

In another exemplary embodiment, a flange may be placed on a portion of the sensing element that is in the water. The flange may add a heat transfer fin to the sensing element. The shank of the sensing element may be a diameter large enough for mounting the thermostat and the flange or head may be on the inside of the boiler.

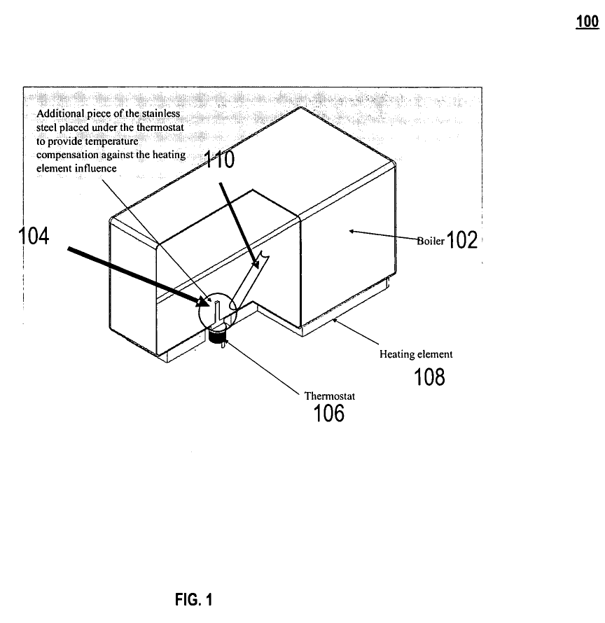

Conventionally, as shown in FIG. 1, the heating element may be near the thermostat and may influence the thermostat. To reduce the influence of the heating element on the thermostat the sensing element may act as a heat sink, and may be placed to compensate for heating element influence. In one exemplary embodiment, the heat sink may use, e.g., but not limited to, the water inside the boiler to keep the thermostat cool enough not to cycle.

One exemplary embodiment may include a stainless steel sensing element. In an exemplary embodiment of the sensing element, the sensing element may be placed inside the boiler, and the head of the sensing element may be used as thermostat placement point. An exemplary embodiment of the present invention may be used in a boiler such as the Euro-Pro Model EP903, available from Euro-Pro Corporation of Boston, Mass., USA. In an exemplary embodiment, a thermostat may include a thermostat of a temperature setting of, e.g., but not limited to, 135° C., and/or 145° C.

In one exemplary embodiment, a boiler may have a heating element within the boiler vessel. In one exemplary embodiment, the heating element may be suspended off of the internal bottom of the boiler. In one exemplary embodiment, the heating element may resemble a coil and may allow more uniform heating of the water than by placing the heating element under the boiler (or at the base of the boiler). In an exemplary embodiment of the invention, where the heating element is within the boiler, the sensing element may be placed in a position within the sensing element so as not to be unduly influenced by the heating element, but so as to sense the temperature of the water within the boiler. In one exemplary embodiment, the sensing element may be at the inside bottom of the boiler vessel and the heating element may be coiled in a tube so water may come up the tube to be heated. A small Aluminum connection, or column support may communicate the temperature to the thermostat according to an exemplary embodiment.

FIG. 1 depicts an exemplary cutaway isometric view 100 of a boiler 102 including a sensing element 104 protruding into the boiler 102, in accordance with an exemplary embodiment of the present invention. The exemplary sensing element 104 depicted may include a screw shaped member as shown in accordance with an exemplary embodiment of the present invention. Also shown is a heating element 108 at the base of the boiler 102 in an exemplary embodiment. A thermostat 106 is shown coupled to the sensing element 104. As shown, a novel piece of stainless steel (for a stainless steel boiler) sensing element 104 may be placed adjacent the thermostat to provide temperature compensation against heating element 108 influence. The sensing element 104 may further include a flange, (not shown) which may serve as a heat transfer fin. The wall of the boiler 102 may include one or more channels 110.

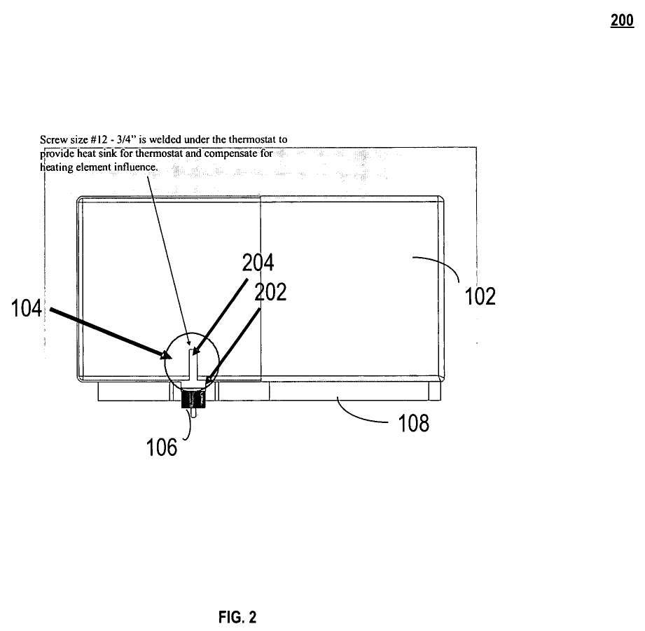

FIG. 2 depicts a side cross-sectional view 200 of an exemplary sensing element 104 depicted including an extension portion 204, a head portion 202 in accordance with an exemplary embodiment of the present invention. Also shown is a heating element 108 at the base of the boiler in an exemplary embodiment. A thermostat 106 is shown coupled to the head portion 202 of the sensing element 104. The extension portion 204 protrudes into the internal vessel of the boiler 102 allowing the water in the boiler to contact the sensing element 104. As shown, sensing element 104 may be a #12-¾″ screw which may be welded to the thermostat to provide a heat sink for the thermostat and may compensate for heating element influence. In other exemplary embodiments, the heating element may be within the boiler vessel (not shown).

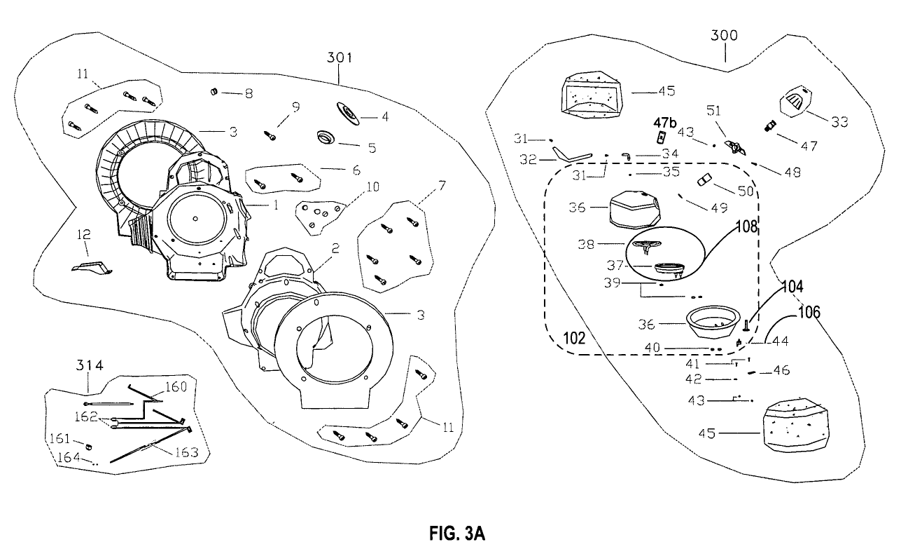

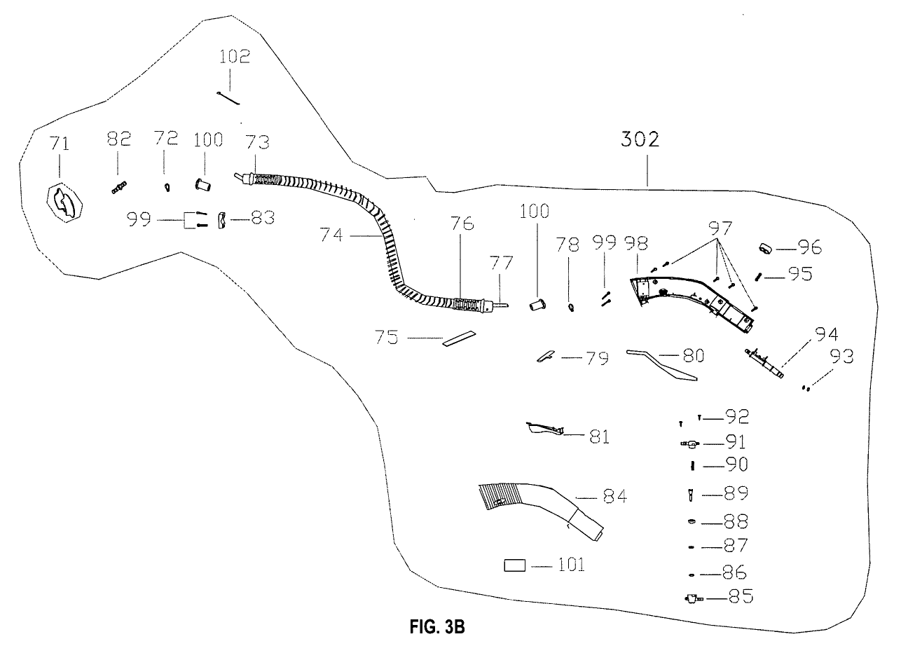

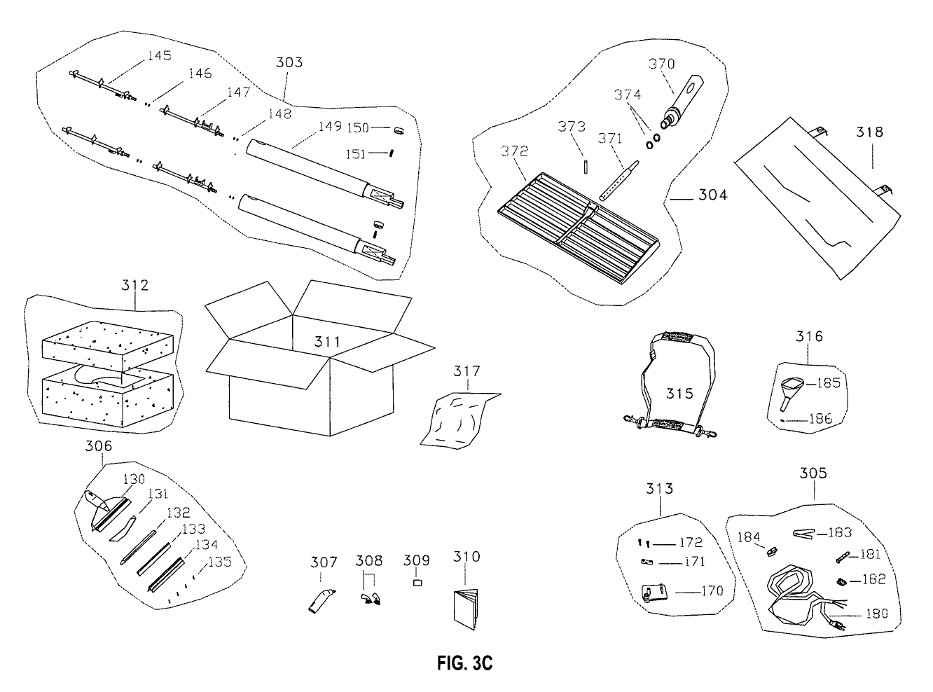

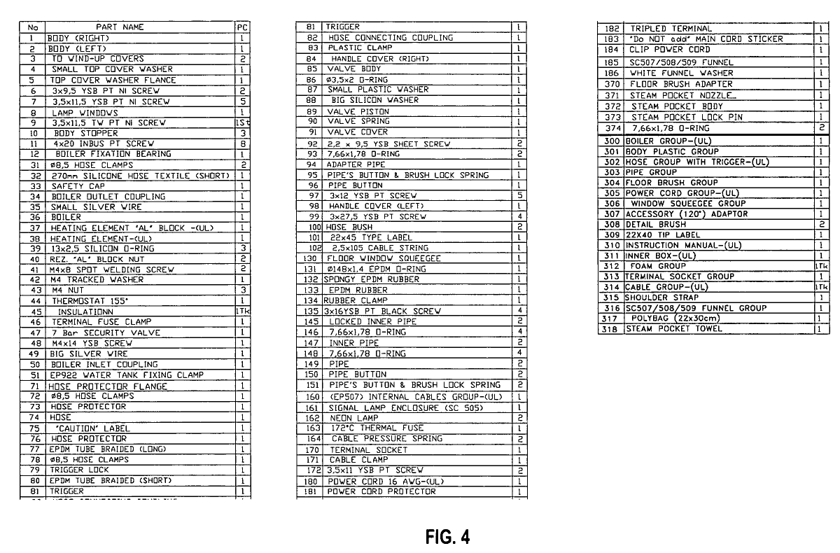

FIG. 3A depicts an exemplary boiler 300 and a housing 301 of an exemplary steam generation device having first and second pressure relief valves in accordance with an exemplary embodiment of the present invention. Various exemplary components are illustrated and defined in the parts list table of FIG. 4. Boiler 300, in an exemplary embodiment, may include a boiler top 36, a boiler bottom 36, heating elements 37, 38, insulation 45, various o-rings, washers, and nuts. According to an exemplary embodiment, boiler 102 as shown may include, a sensing element 104, a thermostat 106, and a heating element 108. According to an exemplary embodiment, housing 301 may include right body portion 1, left body portion 2, windup covers 3 for receiving a power cord, and/or a hose, and various washers, screws, bearings and stoppers. As shown, a thermal fuse 163 may included, as well as a lamp 162 for indicating whether the heating element is heating.

FIG. 3B depicts an exemplary hose group 302 and handle 84, 98 having a trigger 81 of a steam generation device in accordance with an exemplary embodiment of the present invention. Various exemplary components are illustrated and defined in the parts list table of FIG. 4. FIG. 3B, in an exemplary embodiment, includes a hose 74, a handle including a left handle cover 98, a right handle cover 84, a trigger 81, various valve covers, springs, pistons, o-rings, tubes, clamps, cables, lockswashers, screws, clamps, flanges, couplings.

FIG. 3C depicts exemplary accessories including pipes 303, a steam pocket floor brush 304, a squeegee 306, a shoulder strap 315, a funnel 316, and packing materials 311, 312, 317 in accordance with an exemplary embodiment of the present invention. Various exemplary components are illustrated and defined in the parts list table of FIG. 4. In an exemplary embodiment, the steam generation device may include a floor brush 304 including a steam pocket towel 318 covering a steam pocket body 372 coupled to a steam pocket nozzle 371, with steam pocket lock pin 373, o-rings 374, and floor brush adapter 370. Advantageously, the floor brush is reversible providing for double the surface area of a conventional floor brush. FIG. 3C further includes an exemplary pipe group 303 illustrating exemplary pipes 149, with inner pipe 145, 147, o-rings, button and spring. FIG. 3C further illustrates an exemplary squeegee 306 as may be used for cleaning, e.g., windows, floors, etc. Various accessories of the steam generation device are further illustrated including, e.g., a shoulder strap 315, a funnel 316, terminal socket group 313, and power cord 305. Further, exemplary packing materials may include sponge packing 312, box 311, and bag 317.

FIG. 4 depicts a parts list table providing an exemplary detailed list of exemplary, but not limiting, components of the exemplary steam generation device of FIGS. 3A-C according to an exemplary embodiment of the present invention.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it will be understood to those having ordinary skill in the art that changes in the above description or illustrations may be made with respect to formal detail without departing from the spirit and scope of the invention.

1. A steam generation apparatus comprising:
a boiler adapted to generate steam from water;
a thermostat;
a sensing element having a portion protruding inside said boiler adapted to make contact with the water, said sensing element coupled to a bottom wall of said boiler, and said sensing element coupled to said thermostat for providing temperature of the water to said thermostat.

2. The apparatus of claim 1, wherein said boiler comprises at least one of:
stainless steel; or
aluminum.

3. The apparatus according to claim 2, wherein said sensing element comprises at least one of:
stainless steel; or
aluminum.

4. The apparatus according to claim 1, wherein said sensing element comprises a shape comprising at least one of: a screw-shape, a nail-shape, an L-shape, an I-shape, a T-shape.

5. The apparatus according to claim 1, wherein said boiler is part of at least one of:
a steam cleaner; or
an iron steam station.

6. The apparatus according to claim 1, wherein said sensing element is threaded.

7. The apparatus according to claim 6, wherein said sensing element is treaded through a treaded boss in the bottom wall of said boiler.

8. The apparatus according to claim 1, wherein said sensing element passes through the bottom wall of said boiler.

9. The apparatus according to claim 1, wherein said sensing element comprises a first portion inside said boiler and a second portion outside said boiler coupled to said thermostat.

10. The apparatus according to claim 1, wherein said sensing element comprises:
a material matching material used in said boiler.

11. The apparatus according to claim 1, wherein said sensing element comprises:
a material having a substantially similar coefficient of expansion as material used in said boiler.

12. The apparatus according to claim 1, further comprising:
at least one channel in the bottom wall of said boiler adapted to increase surface area of said sensing element in contact with the water.

13. The apparatus according to claim 1, wherein said sensing element comprises:
a flange portion adapted to serve as a heat transfer fin.

14. A boiler for a steam generation apparatus comprising:
a boiler adapted to generate steam from water;
a sensing element having a portion protruding inside said boiler adapted to make contact with the water, said sensing element coupled to a bottom wall of said boiler, and said sensing element adapted to be coupled to a thermostat for providing temperature of the water to the thermostat.

15. The apparatus according to claim 1, wherein said steam generation apparatus further comprises:
a heating element external to and below the bottom of the boiler.

16. The apparatus according to claim 1, wherein said steam generation apparatus further comprises:
a plurality of pressure relief safety valves coupled to the boiler.

17. The boiler according to claim 14, wherein said boiler further comprises:
a heating element coupled externally to and below the bottom of the boiler.

18. The boiler according to claim 14, wherein said boiler further comprises:
a plurality of pressure relief safety valves coupled to the boiler.
